(19) United States
(12) Patent Application Publication
(10) Pub. No.: US 2025/0166599 A1
(43) Pub. Date: May 22, 2025

(54) METHOD AND DEVICE FOR SPEECH SYNTHESIS

(71) Applicants: Hyundai Motor Company, Seoul (KR); Kia Corporation, Seoul (KR)

(72) Inventor: Seong Soo YAE, Hwaseong-si (KR)

(73) Assignees: Hyundai Motor Company, Seoul (KR); Kia Corporation, Seoul (KR)

(21) Appl. No.: 18/940,215

(22) Filed: Nov. 7, 2024

(30) Foreign Application Priority Data
Nov. 20, 2023 (KR) 10-2023-0161153

(51) Int. Cl. G10L 13/02

(52) U.S. Cl. CPC G10L 13/02

(57) ABSTRACT

In a method and device for speech synthesis, the method of outputting text input as sound from an electronic device, includes receiving a text input including characters from at least two languages and at least one symbol, generating a plurality of ordered groups by sequencing, wherein the plurality of ordered groups includes character groups including characters from a common language, and a symbol group including symbols, by segmenting the text input sequentially by language and by symbol, generating sound segments corresponding to each of the character groups by use of a plurality of text-to-speech (TTS) engines supporting different languages, generating an output sound by merging the sound segments according to the sequencing of the character groups within the plurality of ordered groups, and displaying the symbol of the symbol group on a display while outputting the output sound by use of a speaker.

### CROSS-REFERENCE TO RELATED APPLICATION

The present application claims priority to Korean Patent Application No. 10-2023-0161153, filed Nov. 20, 2023, the entire contents of which is incorporated herein for all purposes by this reference.

### BACKGROUND OF THE PRESENT DISCLOSURE

### Field of the Present Disclosure

The present disclosure relates to a method and device for speech synthesis.

### Description of Related Art

The statements in the present section merely provide background information related to the present disclosure and do not necessarily constitute related art.

Text-to-speech (TTS) technology is a computer-based speech synthesis technology that automatically converts text input into speech. TTS technology can play a key role in enabling users to interact with computers, smartphones, or other digital devices.

TTS technology can also be utilized in a variety of applications, such as voice guidance systems, education applications, virtual assistants, and speech-based search, to enhance user experience and provide convenience.

A TTS device supports a TTS engine for a single language or may support a TTS engine for multiple languages, providing synthesized speech exclusive to those languages that it can support. As a result, text input in languages not supported by the TTS device cannot be processed. Attempts to use such TTS devices to accept textual information as speech information will cause important information to be lost or impair the ability to communicate properly.

In response to text input when including symbols such as emoticons or emoji, the TTS device simply provides speech for the word corresponding to the symbol, or no speech at all. As a result, the feeling that the text has is not soundly conveyed to the user of a TTS device.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a method of outputting text input as sound from an electronic device, including receiving a text input including characters from at least two languages and at least one symbol, generating a plurality of ordered groups by sequencing, wherein the plurality of ordered groups includes character groups including characters from a common language, and a symbol group including symbols, by segmenting the text input sequentially by language and by symbol, generating sound segments corresponding to each of the character groups by use of a plurality of text-to-speech (TTS) engines supporting different languages, generating an output sound by merging the sound segments according to the sequencing of the character groups within the plurality of ordered groups, and displaying the symbol of the symbol group on a display while outputting the output sound by use of a speaker.

According to another exemplary embodiment of the present disclosure, the present disclosure provides an electronic device for outputting text input as sound, including a memory configured to store instructions, and at least one processor, wherein the at least one processor is configured to perform a method including receiving a text input including characters from at least two languages and at least one symbol, generating a plurality of ordered groups by sequencing, wherein the plurality of ordered groups includes character groups including characters from a common language, and a symbol group including symbols, by segmenting the text input sequentially by language and by symbol, generating sound segments corresponding to each of the character groups by use of a plurality of text-to-speech (TTS) engines supporting different languages, generating an output sound by merging the sound segments according to the sequencing of the character groups within the plurality of ordered groups, and displaying the symbol of the symbol group on a display while outputting the output sound by use of a speaker.

According to various exemplary embodiments of the present disclosure, the present disclosure provides a non-transitory computer-readable recording medium storing instructions for causing, when executed in a processor, the processor to perform a method including receiving a text input including characters from at least two languages and at least one symbol, generating a plurality of ordered groups by sequencing, wherein the plurality of ordered groups includes character groups including characters from a common language, and a symbol group including symbols, by segmenting the text input sequentially by language and by symbol, generating sound segments corresponding to each of the character groups by use of a plurality of text-to-speech (TTS) engines supporting different languages, generating an output sound by merging the sound segments according to the sequencing of the character groups within the plurality of ordered groups, and displaying the symbol of the symbol group on a display while outputting the output sound by use of a speaker.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a block diagram of an electronic device according to at least an exemplary embodiment of the present disclosure.

FIG. 2 is a flowchart of a method according to various embodiments of the present disclosure.

FIG. 3 is a flowchart of a process for implying text input according to at least an exemplary embodiment of the present disclosure.

FIG. 4 is a flowchart of an exemplary embodiment of Step S23 of FIG. 2.

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

The present disclosure is directed to addressing these issues and providing a method and device for TTS processing of text input including characters from a plurality of languages and at least one symbol, which provides good quality speech and outputs without information loss.

This disclosure is further directed to providing a method and device for TTS processing of text input including characters from a plurality of languages and at least one symbol, which provides a visual output of the at least one symbol to soundly convey to the user the emotion contained in the textual information.

The present disclosure further is directed to providing a method and device for TTS processing of text input that includes an excessive number of characters for emotional expressions, by replacing the characters for emotional expressions with images corresponding to the characters, allowing the information to be implicitly conveyed to the user.

The objects of the present disclosure are not limited to those particularly described hereinabove, and the above and other objects that the present disclosure can achieve will be clearly understood by those skilled in the art from the following detailed description.

Hereinafter, various exemplary embodiments of the present disclosure will be described in detail with reference to the accompanying drawings. In the following description, like reference numerals preferably designate like elements, although the elements are shown in different drawings. Furthermore, the following description of various exemplary embodiments will omit for clarity and for brevity, a detailed description of related known components and functions when considered obscuring the subject of the present disclosure.

Various ordinal numbers or alpha codes such as first, second, i), ii), a), b), etc., are prefixed solely to differentiate one component from the other but not to imply or suggest the substances, order, or sequence of the components. Throughout the present specification, when a part “includes” or “comprises” a component, the part is meant to further include other components, to not exclude thereof unless specifically stated to the contrary.

The technology disclosed herein relates to devices for processing text input that includes characters composed of a plurality of languages and symbols including emojis and emoticons into sound and/or images. The technology of the present disclosure provides a solution for converting to sound from text unsupported by a TTS engine.

The technology according to an exemplary embodiment of the present disclosure may be applied to various fields, such as in-vehicle embedded devices, voice guidance systems, education applications, virtual assistants, and speech-based search.

Some of the exemplary embodiments described below provide a method and device for communicating abstracted information to a user by implicating a large amount of text. Such embodiments of the technology according to an exemplary embodiment of the present disclosure, when configured as an in-vehicle embedded device, can have the effect of reducing driver fatigue by providing information to the driver in an abstracted or implied form.

The description of the present disclosure to be presented below in conjunction with the accompanying drawings is intended to describe exemplary embodiments of the present disclosure and is not intended to represent the only embodiments in which the technical idea of the present disclosure may be practiced.

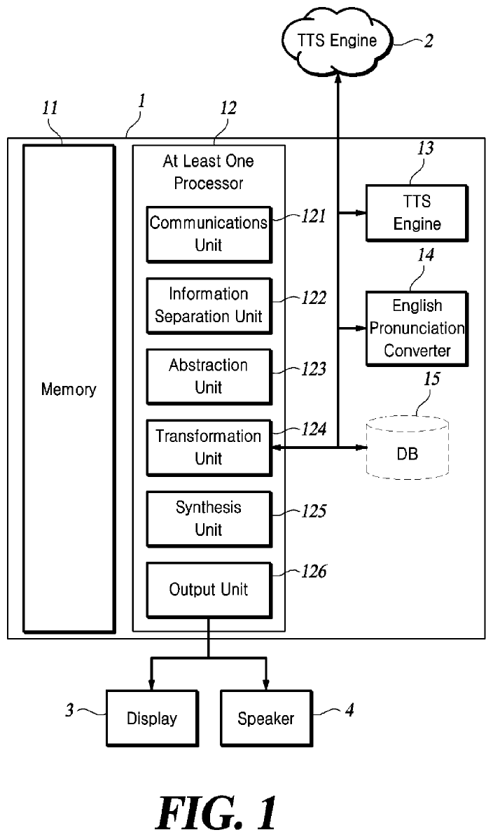

FIG. 1 is a block diagram of an electronic device according to at least an exemplary embodiment of the present disclosure.

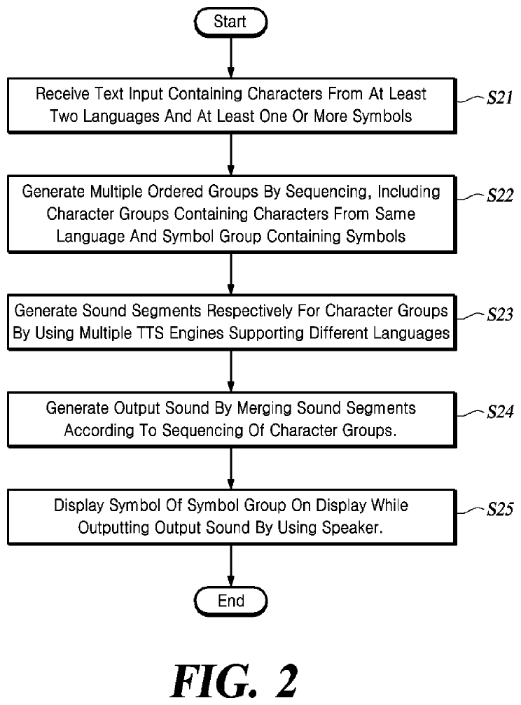

FIG. 2 is a flowchart of a method according to various embodiments of the present disclosure.

Referring to FIG. 1, an electronic device 1 according to at least an exemplary embodiment of the present disclosure may include a memory 11 and at least one processor 12.

The memory 11 may store various data used by the at least one processor 12. The data may include software and input data or output data for instructions associated with the software. The memory 11 may include volatile memory or non-volatile memory.

The at least one processor 12 may include all or part of a communications unit 121, an information separation unit 122, a transformation unit 124, a synthesis unit 125, and an output unit 126.

FIG. 2 is a flowchart of a method according to various embodiments of the present disclosure.

Hereinafter, FIG. 1 and FIG. 2 will be referred to in parallel to describe components of the at least one processor 12 and the steps that the respective components perform.

The communications unit 121 receives a text input including characters from at least two languages and at least one symbol (S21). In at least an exemplary embodiment of the present disclosure, the text input may be provided in response to a query from a user of the electronic device 1, or as a mobile message received on a user terminal communicatively linked to the electronic device 1.

The text may be text data categorized using various codes and encoded in various ways. In at least an exemplary embodiment of the present disclosure, characters and symbols may be provided as data represented by Unicode and encoded using UTF-8.

In addition to receiving text input, the communications unit 121 may also be configured to transmit text output. When the communications unit 121 transmits text output, the text input may be represented in Unicode and transmitted as data encoded using UTF-8.

The information separation unit 122 sequentially segments the text input by language and by symbol to generate a plurality of ordered groups by sequencing, including character groups composed of characters from the same language and a symbol group composed of symbols (S22).

In at least an exemplary embodiment of the present disclosure, the information separation unit 122 identifies the language of the text by use of Unicode. For example, if the input text is “ [symbol] [symbol] goodbye [symbol] ” the information separation unit 122 identifies based on code points in Unicode that “ [symbol] ” (Hello) and “ [symbol] ” (See you again) are text composed in Korean, “ [symbol] ” (Nice to meet you) is text composed in Japanese, and “goodbye” is text composed in English. In contrast, if the text is composed of symbols such as emoji or emoticons, the information separation unit 122 identifies that the text is composed of symbols based on code points in the range U+1F600 to U+1F6FF of Unicode.

In at least an exemplary embodiment of the present disclosure, the information separation unit 122 is configured to perform a mapping of the text input to generate a plurality of groups composed of characters from the same language. With the illustrative example text above, the information separation unit 122 may map the text as “ [symbol] (KO, D1),” “ [symbol] (JA, D2),” “goodbye (EN, D3),” and “ [symbol] (KO, D4)”. KO, JA, and EN are Unicode's country-specific language tags for Korean, Japanese, and English, respectively. Symbols may be mapped by defining language tags such as EM or ET.

In at least an exemplary embodiment of the present disclosure, the information separation unit 122 is configured to perform mapping to sequentially segment groups of text input. With the illustrative example text above, when the information separation unit 122 is configured to perform a mapping to sequentially segment the groups of the text input, it may map the text as “ [symbol] (D1),” “ [symbol] (D2),” “goodbye (D3),” and “ [symbol] (D4).” In the present example, Dn represents the order in the text, and the information separation unit 122 generates multiple ordered groups by ascending the value of n each time the group changes.

One example of the plurality of ordered groups generated from the information separation unit 122 is shown using Table 1 and Table 2.

TABLE 1

| Text | [symbol] , we are one! [symbol] ! [symbol] | | | |
|---|---|---|---|---|
| Text Input | Encoded Data By Using Unicode and UTF-8 (See Table 2) | | | |
| Multiple | KO: D1 | EN: D2 | JA: D3 | EM: D4 |
| Ordered | (Encoded | (Encoded | (Encoded | (Encoded |
| Groups | Data) | Data) | Data) | Data) |

TABLE 2

| Text | Unicode Code Point | UTF-8 Code |
|---|---|---|
| [symbol] | U + C544 U + C548 U + C54A | ea bc 9c |
| | U + C548 | |
| [symbol] | U + C548 U + C54C U + C545 | ea bd 80 |
| | U + C54A | |
| , | U + 002C | 2c |
| we | U + 0077 U + 0065 | 77 65 |
| are | U + 0061 U + 0072 | 72 61 |
| one | U + 006F U + 006E | 6e |
| ! | U + 0021 | 21 |
| [symbol] | U + 4E16 U + 4E2D U + 4E16 | e4 b8 80 e4 b8 8d e4 |
| | U + 4E2D U + 4E00 U + 4E2D | b8 80 e4 b8 8d e4 b8 |
| | U + 3059 U + 305B U + 3061 | 80 e4 b8 a5 e3 81 9d |
| | | e3 81 9e e3 81 a1 |
| [symbol] | U + 1F97A | 0xF0 9F 98 A9 |

The transformation unit 124 generates sound segments for each of the character groups by use of a plurality of TTS engines 2 and 13 supporting different languages (S23). The sound segments may be data in WAVE format, but may also be provided as data in formats such as, but not limited to, MP3 and FLAC.

In at least an exemplary embodiment of the present disclosure, the plurality of TTS engines 2, 13 may be provided as TTS engines 13 embedded in the electronic device 1, TTS engines 2 provided by a server communicatively linked to the electronic device 1, or a combination thereof.

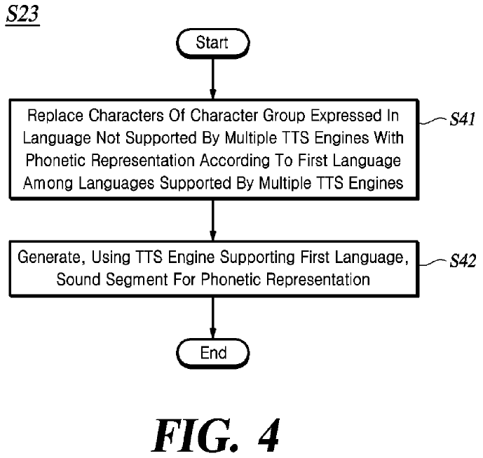

FIG. 4 is a flowchart of an exemplary embodiment of Step S23 of FIG. 2.

Referring to FIG. 4, in at least an exemplary embodiment of the present disclosure, the transformation unit 124 replaces characters of a character group expressed in a language not supported by the plurality of TTS engines 2, 13 with phonetic representations according to a first language among the languages supported by the plurality of TTS engines 2, 13 (S41). For example, if the plurality of TTS engines 2, 13 do not support a TTS engine for Russian, the transformation unit 124 replaces the character group composed of Russian with a phonetic representation according to English, using an English pronunciation converter 14. As a concrete example, the Russian character group “ [symbol] ” is replaced with the English phonetic representation “privet.”

In at least an exemplary embodiment of the present disclosure, after Step S41, the transformation unit 124 generates sound segments for the phonetic representation by use of a TTS engine that supports the first language (S42).

Referring back to FIG. 1 and FIG. 2, the synthesis unit 125 merges the sound segments according to the sequencing of the character groups in the multiple ordered groups to generate an output sound (S24). The merging of the sound segments may be performed using various methods, such as a simple chronological concatenation of the respective speech information items based on the order of the character groups in the multiple ordered groups, or a natural concatenation by adjusting the frequency characteristics of the respective sound segments.

The output unit 126 transmits the symbol of the symbol group to a display 3 and transmits the output sound to a speaker 4, displaying the symbol of the symbol group on the display 3 and outputting the output sound through the speaker 4 (S25).

In at least an exemplary embodiment of the present disclosure, the output unit 126 may be provided as a head-up display (HUD) of a vehicle provided with the electronic device 1.

In at least an exemplary embodiment of the present disclosure, the electronic device 1 may be configured to stop displaying a symbol of the symbol group on the display 3 upon termination of the output of the sound segment corresponding to the character group preceding the symbol group. For example, it is assumed to output data generated based on a text input such as “Don't be too heartbroken because it is a common belief that it is wrong to think that no one knows the will of the heavens [symbol] ”. The electronic device 1 may be configured to display ‘ [symbol] ’ on the display 3 until the termination of outputting the output sound based on the character group preceding the symbol group, which reads “Don't be too heartbroken because it is a common belief that it is wrong to think that no one knows the will of the heavens.”

In at least an exemplary embodiment of the present disclosure, the electronic device 1 may be configured so that the displaying the symbol of the symbol group on the display 3 is timed based on the position of the character group preceding the symbol group and the number of characters in the character group preceding the symbol group. For example, when outputting data generated based on the text input such as “Don't be too heartbroken because it is a common belief that it is wrong to think that no one knows the will of the heavens [symbol] ,” the electronic device 1 may be configured to display the symbol based on ‘ [symbol] ’ on the display 3 from the start of outputting the output sound based on “to think” to the end of outputting the output sound based on “the heavens.”

In at least an exemplary embodiment of the present disclosure, the at least one processor 12 may further include an abstraction unit 123.

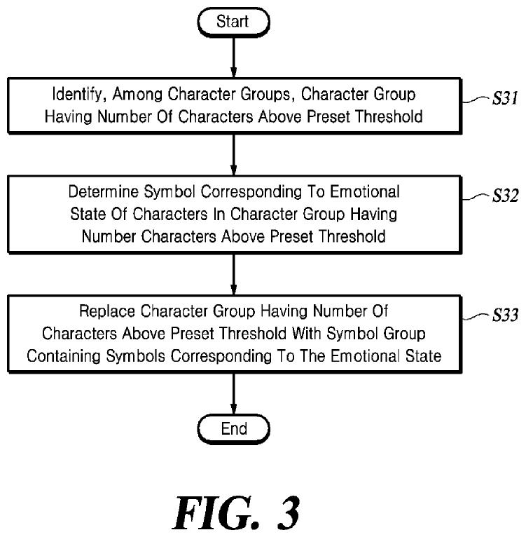

FIG. 3 is a flowchart of a process for abstracting or implying text input according to at least an exemplary embodiment of the present disclosure.

Referring to FIG. 3, after the information separation unit 122 generates multiple ordered groups (S22), it identifies a character group including a number of characters above a preset threshold among the character groups (S31).

The abstraction unit 123 is configured to determine a symbol corresponding to the emotional state of the characters in the character group including the number of characters above the preset threshold (S32).

In at least an exemplary embodiment of the present disclosure, the abstraction unit 123 may be connected to a database (DB) 15 in which the characters and symbols representing the emotional states are mutually mapped and stored. In other words, in at least an exemplary embodiment of the present disclosure, the abstraction unit 123 may be configured to perform Step S32 by use of the DB. One example of the DB is shown in Table 3.

TABLE 3

| String | Symbol | Unicode |
|---|---|---|
| Heh, heh, heh | [symbol] | U + 1F604 |
| Sad, heartbroken | [symbol] | U + 1F622 |
| Ridiculous | [symbol] | U + 1F612 |

The abstraction unit 123 replaces the character group having the number of characters above the preset threshold with a symbol group composed of symbols corresponding to the emotional state (S33).

The abstraction unit 123 may be activated or deactivated as selected by the user. Synthesizing speech based on an excessively large amount of textual data and presenting the whole speech to the user may aggravate user fatigue. The abstraction unit 123 can abbreviate the excessive amount of text input and process the information based on the abbreviated text input, thereby providing the user with denser information without increasing user fatigue.

The device or method according to an exemplary embodiment of the present disclosure may include the respective components arranged to be implemented as hardware or software, or hardware and software combined. Additionally, each component may be functionally implemented by software, and a microprocessor may execute the function by software for each component when implemented.

Various illustrative implementations of the systems and methods described herein may be realized by digital electronic circuitry, integrated circuits, field-programmable gate arrays (FPGAs), application-specific integrated circuits (ASICs), computer hardware, firmware, software, and/or their combination. These various implementations may include those realized in one or more computer programs executable on a programmable system. The programmable system includes at least one programmable processor coupled to receive and transmit data and instructions from and to a storage system, at least one input device, and at least one output device, wherein the programmable processor may be a special-purpose processor or a general purpose processor. The computer programs (which are also known as programs, software, software applications, or code) include instructions for a programmable processor and are stored in a “non-transitory computer-readable recording medium.”

The non-transitory computer-readable recording medium includes any type of recording device on which data which may be read by a computer system are recordable. Examples of non-transitory computer-readable recording mediums include non-volatile or non-transitory media such as a ROM, CD-ROM, magnetic tape, floppy disk, memory card, hard disk, optical/magnetic disk, storage devices, and the like. The non-transitory computer-readable recording mediums may further include transitory media such as a data transmission medium. Furthermore, the non-transitory computer-readable recording medium may be distributed in computer systems connected via a network, wherein the computer-readable codes may be stored and executed in a distributed mode.

Although the steps in the respective flowcharts/timing charts are described to be sequentially performed, they merely instantiate the technical idea of various exemplary embodiments of the present disclosure. Therefore, a person including ordinary skill in the pertinent art could perform the steps by changing the sequences described in the respective flowcharts/timing charts or by performing two or more of the steps in parallel, and hence the steps in the respective flowcharts/timing charts are not limited to the illustrated chronological sequences.

As described above, various exemplary embodiments of the present disclosure include an effect of providing a method and device for TTS processing of text input including characters from a plurality of languages and at least one symbol to provide good quality speech and outputs without information loss.

The present disclosure can further provide a method and device for TTS processing of text input including characters from a plurality of languages and at least one symbol to provide a visual output of the at least one symbol to soundly convey to the user the emotion contained in the textual information.

The present disclosure can further provide a method and device for TTS processing of text input that includes an excessive number of characters for emotional expressions, by replacing the characters for emotional expressions with images corresponding to the characters, allowing the information to be implicitly conveyed to the user.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A method of outputting text input as sound from an electronic device, the method comprising:
receiving, by at least one processor, a text input including characters from at least two languages and at least one or more symbols;
generating, by the at least one processor, a plurality of ordered groups by sequencing, wherein the plurality of ordered groups includes character groups including characters from a common language, and a symbol group including symbols, by segmenting the text input sequentially by language and by symbol;
generating, by the at least one processor, sound segments corresponding to each of the character groups by use of a plurality of text-to-speech (TTS) engines supporting different languages;
generating, by the at least one processor, an output sound by merging the sound segments according to the sequencing of the character groups within the plurality of ordered groups; and
displaying, by the at least one processor, the symbols of the symbol group on a display and outputting the output sound by use of a speaker.

2. The method of claim 1, further including:
replacing, by the at least one processor, characters of a character group expressed in a language not supported by the plurality of TTS engines with a phonetic representation according to a first language among the different languages supported by the plurality of TTS engines; and
generating, by the at least one processor, using a TTS engine supporting the first language among the plurality of TTS engines, a sound segment for the phonetic representation.

3. The method of claim 1, further including:
stopping, by the at least one processor, the displaying of the symbols of the symbol group on the display upon termination of an output of a sound segment corresponding to a character group preceding the symbol group.

4. The method of claim 1, wherein the displaying of the symbols of the symbol group on the display is timed based on a position of a character group preceding the symbol group and a number of characters in the character group preceding the symbol group.

5. The method of claim 1, further including:
identifying, by the at least one processor, among the character groups, a character group including a number of characters above a preset threshold;
determining, by the at least one processor, a symbol corresponding to an emotional state of characters in the character group including the number of characters above the preset threshold; and
replacing, by the at least one processor, the character group including the number of characters above the preset threshold with a symbol group including the symbol corresponding to the emotional state.

6. The method of claim 1, wherein the characters and the symbols in the text input include characters and symbols represented by Unicode.

7. The method of claim 1, wherein the text input is provided in response to a query from a user of the electronic device, or provided as a mobile message received on a user terminal communicatively linked to the electronic device.

8. The method of claim 1, wherein the plurality of TTS engines includes:
TTS engines embedded in the electronic device, TTS engines provided by a server communicatively linked to the electronic device, or a combination of the TTS engines in the electronic device and the TTS engines by the server.

9. The method of claim 1, wherein the display includes a heads-up display of a vehicle provided with the electronic device.

10. An electronic apparatus for outputting text input as sound, the apparatus comprising:
a memory configured to store instructions; and
at least one processor configured to execute the instructions,
wherein the at least one processor is configured for, by executing the instructions:
receiving the text input including characters from at least two languages and at least one or more symbols;
generating a plurality of ordered groups by sequencing, wherein the plurality of ordered groups includes character groups including characters from a common language, and a symbol group including symbols, by segmenting the text input sequentially by language and by symbol;
generating sound segments corresponding to each of the character groups by use of a plurality of text-to-speech (TTS) engines supporting different languages;
generating an output sound by merging the sound segments according to the sequencing of the character groups within the plurality of ordered groups; and
displaying the symbols of the symbol group on a display and outputting the output sound by use of a speaker.

11. The electronic apparatus of claim 10, wherein the at least one processor is configured to further perform:
replacing characters of a character group expressed in a language not supported by the plurality of TTS engines with a phonetic representation according to a first language among the different languages supported by the plurality of TTS engines; and
generating, using a TTS engine supporting the first language among the plurality of TTS engines, a sound segment for the phonetic representation.

12. The electronic apparatus of claim 10, wherein the at least one processor is configured to further perform:
stopping the displaying of the symbols of the symbol group on the display upon termination of an output of a sound segment corresponding to a character group preceding the symbol group.

13. The electronic apparatus of claim 10, wherein the displaying of the symbols of the symbol group on the display is timed based on a position of a character group preceding the symbol group and a number of characters in the character group preceding the symbol group.

14. The electronic apparatus of claim 10, wherein the at least one processor is configured to further perform:
identifying, among the character groups, a character group including a number of characters above a preset threshold;
determining a symbol corresponding to an emotional state of characters in the character group including the number of characters above the preset threshold; and
replacing the character group including the number of characters above the preset threshold with a symbol group including the symbol corresponding to the emotional state.

15. The electronic apparatus of claim 10, wherein the characters and the symbols in the text input include characters and symbols represented by Unicode.

16. The electronic apparatus of claim 10, wherein the text input is provided in response to a query from a user of the electronic apparatus, or provided as a mobile message received on a user terminal communicatively linked to the electronic apparatus.

17. The electronic apparatus of claim 10, wherein the plurality of TTS engines includes:
TTS engines embedded in the electronic apparatus, TTS engines provided by a server communicatively linked to the electronic apparatus, or a combination of the TTS engines in the electronic apparatus and the TTS engines by the server.

18. The electronic apparatus of claim 10, wherein the display includes a heads-up display of a vehicle provided with the electronic apparatus.

19. A non-transitory computer-readable recording medium storing instructions executed in at least one processor for causing the at least one processor to perform:
receiving a text input including characters from at least two languages and at least one symbol;
generating a plurality of ordered groups by sequencing, wherein the plurality of ordered groups includes character groups including characters from a common language, and a symbol group including symbols, by segmenting the text input sequentially by language and by symbol;
generating sound segments corresponding to each of the character groups by use of a plurality of text-to-speech (TTS) engines supporting different languages;
generating an output sound by merging the sound segments according to the sequencing of the character groups within the plurality of ordered groups; and
displaying the symbols of the symbol group on a display and outputting the output sound by use of a speaker.

20. The non-transitory computer-readable recording medium of claim 19, wherein the at least one processor is configured to further perform:
replacing characters of a character group expressed in a language not supported by the plurality of TTS engines with a phonetic representation according to a first language among the different languages supported by the plurality of TTS engines; and
generating, using a TTS engine supporting the first language among the plurality of TTS engines, a sound segment for the phonetic representation.
